(19) United States
(12) Patent Application Publication
(10) Pub. No.: US 2025/0280806 A1
(43) Pub. Date: Sep. 11, 2025

(54) COATING FOR ENHANCED SONAR TRACKING OF FISHING ATTRACTANTS

(71) Applicant: Michael L. Roller, Purdy, MO (US)

(72) Inventor: Michael L. Roller, Purdy, MO (US)

(21) Appl. No.: 19/060,997

(22) Filed: Feb. 24, 2025

Related U.S. Application Data
(60) Provisional application No. 63/562,332, filed on Mar. 7, 2024.

(51) Int. Cl. A01K 85/01; B05D 5/06; C09D 1/00; C09D 5/33

(52) U.S. Cl. CPC A01K 85/011; B05D 5/063; C09D 1/00; C09D 5/004

(57) ABSTRACT

A fishing attractant for use in combination with a sonar tracking device includes an outer surface that is at least partially coated with a composition that enhances tracking of the fishing attractant by the sonar tracking device. The composition includes at least one metal or metal alloy that reflects a sonar beam transmitted by the sonar tracking device.

### CROSS-REFERENCE TO RELATED APPLICATION

This application claims priority to U.S. Provisional Application No. 63/562,332 filed on Mar. 7, 2024, which is incorporated herein by reference in its entirety.

### FIELD

This disclosure relates generally to a fishing attractant and, more particularly, to a fishing attractant have a coating applied at least partially thereon to enhance tracking of the fishing attractants when used in combination with a sonar tracking device.

### BACKGROUND

Fishing attractants have been used by fishermen for centuries to attract fish and other aquatic species to a lure and/or to a baited hook attached to a lure. Various types of lures are known having many different designs and surface features. For example, some known lures are designed with surface patterns and other geometrical features to mimic a certain type of natural bait, small fish or other prey, such as the gills, throat, or eyes thereof, in order to attract a desired fish. It is also known that light attracts fish, and to this end various known lures include a painting or coating that provides the lure with a light reflecting property, or the lure may be made of a material that has been highly polished to a reflective finish. Thus, fishing lures may vary greatly in size, shape, appearance, surface finish, and composition depending on a desired application.

Fish tracking or “fish finding” devices are also known that are designed to display information to a user related to the location and activity of underwater objects (e.g., fish and other aquatic species) in the vicinity of a boat or vessel. For example, sonar devices are known and display information to the user on a display device that indicates the location and activity of underwater objects in the vicinity of the vessel based on return signals produced in response to sound navigation and ranging (sonar) transmissions into the water (e.g., reflections or echoes produced by fish obstructing the path of the of sonar transmissions). Sonar fish finding devices typically include one or more transmit devices to generate a sonar beam into a body of water and one or more receive devices to detect the reflections of the sonar beam. The sonar fish finding devices may also include a processing element that calculates sonar data based on the reflections to generate a sonar image that is shown on the display device. The sonar image typically includes a representation of underwater objects (e.g., fish and other aquatic species) in the vicinity of the vessel on which the sonar display device may be mounted. Examples of sonar fish finding devices are described in U.S. Pat. No. 4,879,697, filed Aug. 5, 1988, U.S. Pat. No. 5,930,200, filed May 8, 1998, U.S. Pat. No. 6,377,516, filed Dec. 8, 2000, U.S. Pat. No. 8,305,844, filed Aug. 7, 2009, U.S. Pat. No. 9,664,783, filed January 243, 2015, U.S. Pat. No. 9,784,825, filed Jan. 23, 2016, and U.S. Pat. No. 10,514,451, filed May 19, 2017, the disclosures of which are hereby incorporated by reference herein in its entirety.

One problem associated with known fishing attractants used in combination with sonar fish finding tracking devices is that it is difficult to generate a sonar image of the fishing attractants to represent the location of the fishing attractant, relative to the location of other underwater objects. A user may desire to know the relative positioning of the fishing attractant to determine whether the bait and hook is suitably located in the vicinity of the fish, and the location of the fishing attractant may not be otherwise known due to, for example, haziness of the water and/or depth of the lure, and the lure may be in constant or periodic motion due to water current or movement of the vessel. However, known fishing attractant do not produce adequate reflections of the sonar beam and, as a result, sonar data associated with the lure is not adequately captured and an adequate resulting sonar image is not generated. The inability of known lures to reflect sonar beams may be due to their small size and/or the material forming the fishing attractant. Furthermore, passive sonar reflectors applied to the fishing attractant cannot be effectively used because the reflectors would change the appearance and motion of the fishing lure. These effects are highly undesirable since they make the lure “unnatural” and will repel, rather than attract, a fish.

Accordingly, a need exists for an improvement for fishing attractants that has enhanced tracking capability when used in combination with a fish finding device. Moreover, a need exists for a cost-effective solution that enables existing fishing attractant to be retrofitting with enhanced tracking capability without substantially deteriorating other advantageous properties of the fishing attractant, such as light reflecting properties and other surface design features that are useful for attracting fish.

### BRIEF DESCRIPTION

In one aspect, a fishing attractant for use in combination with a sonar tracking device is provided. The fishing attractant includes an outer surface that is at least partially coated with a composition that enhances tracking of the fishing attractant by the sonar tracking device. The composition includes at least one metal or metal alloy that reflects a sonar beam transmitted by the sonar tracking device.

In one aspect, a composition for use in combination with a fishing attractant is provided. The composition includes at least one metal or metal alloy that reflects a sonar beam transmitted by the sonar tracking device.

In one aspect, a method for enhancing the tracking of a fishing attractant by a sonar tracking device is provided. The method includes applying a composition on an outer surface of a fishing attractant. The composition includes at least one metal or metal alloy that reflects a sonar beam transmitted by the sonar tracking device.

### BRIEF DESCRIPTION OF THE DRAWINGS

FIG. 1 is a block diagram of an underwater imaging system that includes a fishing lure used in combination with a sonar tracking device;

FIG. 2 shows an example fishing lure used in the system of FIG. 1 that includes a coating to enhance tracking of the fishing lure in accordance with the present disclosure; and

FIG. 3 illustrates the system of FIG. 1 in operation by a user of a marine vessel.

The following detailed description is to be read with reference to the figures, in which like elements in different figures have like reference numerals. The figures, which are not necessarily to scale, depict selected embodiments and are not intended to limit the scope of the present disclosure. Skilled artisans will recognize the examples provided herein have many useful alternatives and fall within the scope of the present disclosure.

### DETAILED DESCRIPTION

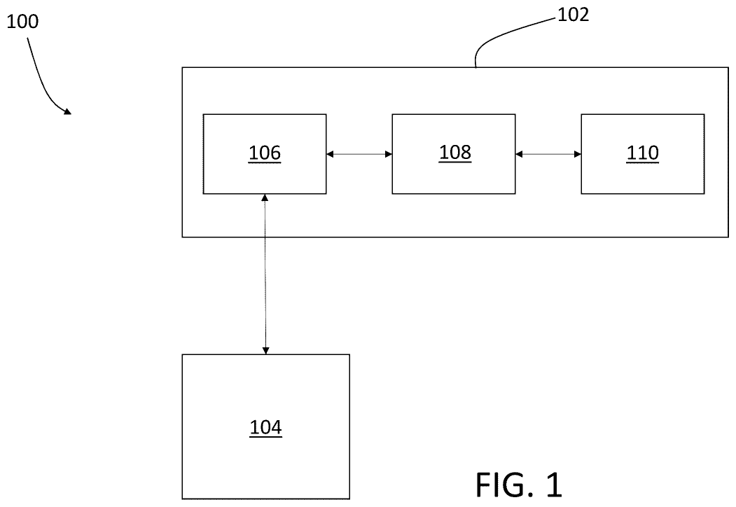

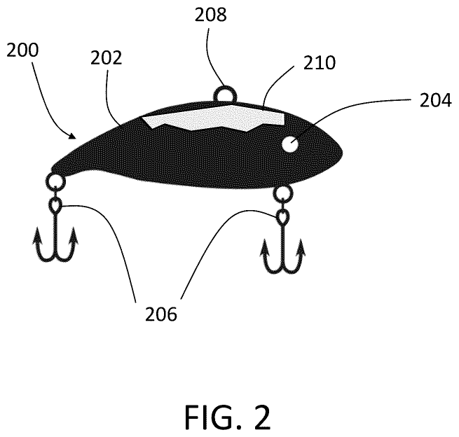

FIG. 1 shows an exemplary underwater imaging system 100 including a sonar tracking device 102 and a fishing attractant 104. The sonar tracking device 102 includes a sonar transducer 106, an imaging module 108, and a display 110. The sonar transducer 106 transmits and receives sonar signals. In particular, the sonar transducer 106 transmits sonar signals (also referred to herein as a sonar beam) into a body of water. Objects in the body of water (e.g., fish and fishing attractant 104) obstruct the path of the sonar signals transmitted by the sonar transducer 106 and produce reflected signals or echoes in response, which are received by the sonar transducer 106. Although the sonar tracking device 102 is shown including one sonar transducer 106, any numbers of sonar transducers may be included in the sonar tracking device 102. The imaging module 108 is in communication with the sonar transducer 106 and processes the sonar signals received by the sonar transducer 106. The imaging module 108 then generates sonar images based on the processed sonar signals that are displayed on the display 110. The sonar images displayed on display 110 are associated with the underwater environment, specifically, depicting the location of the underwater objects that obstruct the sonar signals and produce the reflected signals received by the sonar transducer 106. The sonar tracking device 102 may suitably be mounted to or otherwise integrated into a marine vessel (e.g., vessel 112 shown in FIG. 2). The sonar tracking device 102 may be a stock off-the-shelf system, or a custom sonar system configured to interact with the lure 104. Non-limiting examples of a commercially available sonar tracking device 102 for use in the system 100 include the STRIKER™ fish finders available from GARMIN®.

The sonar transducer 106, the imaging module 108, and the display 110 may communicate via wired or wireless communication. For example, the sonar transducer 106 may receive the reflected sonar signals at a first location and wirelessly communicate the received signals to the imaging module 108 and display 110 at a second location mounted on the vessel 112 using Bluetooth®, WiFi, or any other wireless communication technique known in the art.

The fishing attractant 104, shown in a highly schematic manner in FIG. 1, may embody myriad designs and decorations, and may be utilized in fresh water or saltwater fishing for a wide variety of fish species or other aquatic species. The specific design and decoration of the fishing attractant 104 varies depending, for example, on the water being fished, the time of day, the species of fish sought, personal choice, and many other factors. Generally, the fishing attractant 104 is designed and decorated to attract fish or other aquatic species desired to be caught and entice the fish to bite the lure or a hook connected to or located adjacent to the fishing attractant 104. The fishing attractant 104 may be artificial or, in some embodiments, may comprise live bait or prey (e.g., a worm, minnow, tadpole, frog, mouse, insect, salamander, another small fish, or another food source). Artificial fishing attractants 104 may suitably be designed and decorated to mimic such live bait or prey, including the appearance and movement thereof. In an effort to make an artificial fishing attractant 104 resemble the live bait or prey, the fishing attractants 104 may be fabricated from materials pigmented with desired colors (e.g., colored plastics or rubber). In addition, the artificial fishing attractants 104 may be painted or stained on an outer surface thereof to achieve the desired color and marking characteristics. Decorative features such as scales, eyes, and fins may be painted onto the surface or otherwise added to the artificial fishing attractants 104. Additionally, the fishing attractants 104 may be painted or stained with a light-reflecting coating (e.g., a polish) or another suitable coating with light reflectivity characteristics. For example, the fishing attractants 104 may be painted or stained with a coating that appears to change colors in response to reflected light.

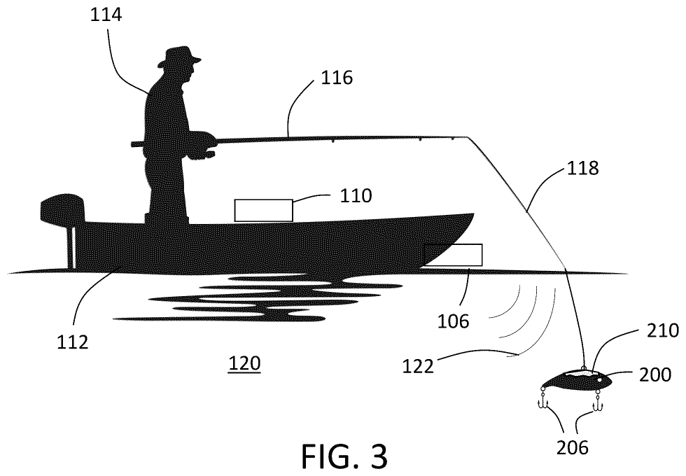

Referring to FIG. 2, an example lure 200 used as the fishing attractants 104 in the underwater imaging system 100 is shown. The lure 200, in this example, is an artificial lure 200 and includes a body 202 designed to resemble a small fish. The body 202 may alternatively have any size and shape to resemble a desired live bait or prey, such as those described above. The lure 200 includes a decorative element 204 on the body 202 to further mimic the appearance of the desired live bait or prey. In this example, the decorative element 204 is light-reflecting and designed to resemble an eye of the small fish. The decorative element 204 may be painted on the body 202 of the lure 200, for example, or may be formed by a separate material attached to the body 202 (e.g., a glass bead). The lure 200 also includes a pair of hooks 206 attached to the body 202. Although two hooks 206 are included in the example lure 200, any number of hooks 206 may be used, such as one or more hooks 206. The lure 200 also includes a loop 208 that is used to attach the lure 200 to a line 118, or a weight or a leader of the line 118, of a fishing rod 116 (shown in FIG. 3). Live fishing attractants may also be used and may be attached to (baited on) hooks that are separately attached to the line 118.

The lure 200 also includes a coating 210 applied to the body 202 of the lure 200. The coating 210 includes a metal or metal alloy material that is capable of reflecting sonar signals transmitted by the sonar transducer 106 of the sonar tracking device 102 (FIGS. 1 and 3). Thereby, the coating 210 enhances the ability of the sonar tracking device 102 to track the lure 200 as the lure 200 is adapted, via the coating 210, to appear on the sonar images displayed on the display 110. As a result, the position of the lure 200 having the coating 210 relative to the fish and/or various other underwater objects and species may be determined by a user 114 of the sonar tracking device 102.

In the example embodiment, the coating 210 only partially covers the body 202 of the lure 200. Suitably, the coating 210 covers a portion of the body 202 such that the decorative element 204 is not interfered by the coating 210. The area of the body 202 covered by the coating 210 is suitably oriented toward the sonar tracking device 102 in operation so that the portion of the body 202 covered by coating 210 obstructs and reflects the sonar signals transmitted by the sonar transducer 106. In the example lure 200, the coating 210 covers a top portion of the body 202, although the coating 210 may cover any suitable portion of the body 202. In other examples, the coating 210 may entirely cover or substantially cover the body 202.

The coating 210 may be applied to the body 202 as a coating composition that includes the metal or metal alloy material suspended in a liquid solution. The metal or metal alloy material may be added to the composition in powdered or particulate form. Suitably, the metal or metal alloy material includes tungsten which has been shown to perform exceptionally well in reflecting sonar signals. Tungsten material suitable for use in the composition of the present disclosure is commercially available as high density (over 99% or even 99.9% purity) tungsten powder.

The amount of metal or metal alloy material (e.g., tungsten or tungsten alloy) included in the coating 210 may be any suitable amount that facilitates reflecting sonar signals. For example, the coating composition may include at least about 1% by weight metal or metal alloy material. In some embodiments, the coating composition includes at least about 5% by weight, or even at least about 10% by weight metal or metal alloy material. In various embodiments, the coating composition may include from about 1% to about 50% by weight, from about 5% to about 25% by weight, or from about 10% to about 20% by weight metal or metal alloy material. In some embodiments, the coating composition includes up to (no more than) 25% by weight inert material particles. For purposes of the present disclosure, and unless specifically described otherwise, percent inclusion of components of the “coating composition” or simply “composition” refer to the material (e.g., the weight metal or metal alloy material suspended in the liquid solution) that is initially applied to the body 202 of the lure 200, and not the coating 210 itself which may form after additional processing steps, intended or incidental (e.g., vaporization of mediums). Unless specifically described otherwise, percent (%) by weight of a component means the amount of the component in the composition, based on the total weight of the composition.

When applied in the form of a liquid solution having suspended metal or metal alloy material, the coating composition used to form the coating 210 includes additional components such as a medium, binder, dispersant, and the like. Components contemplated for use in the coating composition in addition to the metal or metal alloy material will now be described.

The composition may include a medium in which the metal or metal alloy material remains substantially in particulate form. Generally, it should be understood that one or more of the metal or metal alloy, and additives such as a binder, dispersant, stabilizer, and the like may not dissolve, partially dissolve or fully dissolve in the medium and the terms “medium,” “diluent,” and “solvent” may be used interchangeably and are not meant to limit embodiments of the present disclosure to compositions wherein one or more components do or do not dissolve in the medium.

The medium may include an organic compound or may be aqueous (e.g., water). Organic mediums include volatile solvents such as alcohols and ketones. For example, the medium may include a C1 to C10 alcohol and may be isopropyl alcohol or ethanol. Non-limiting examples of ketones include acetone, methyl ethyl ketone, and diethyl ketone. Ethyl acetate, butyl acetate, propyl acetate, isopropyl acetate, and toluene are other mediums that may be used. The amount of the medium may be selected to obtain a suitable fluid viscosity of the liquid coating composition. In some embodiments, the coating composition includes at least about 10% by weight medium. In other embodiments, the composition may include at least about 30%, at least about 50%, or even at least about 70% by weight medium. In various other embodiments, the composition includes from about 1% to about 99% by weight medium. The composition may include more than one medium with the total weight fraction of medium in the composition being as described above. It should be appreciated that the composition may include other amounts of the medium in order to obtain a suitable fluid viscosity of the liquid coating composition. The amount of the medium may vary depending on, for example, the type of medium used (e.g., organic or aqueous).

The coating composition may also include one or more binders. The binders act to bind the components of the composition and, more particularly, the particles of the metal or metal alloy material suspended in the liquid solution, to the body 202 of the lure 200 and to each other after application and throughout drying to form the coating 210. In some embodiments, the binder is dissolved in the medium. Suitable binders include polymeric film-forming and adhesive resins, and may be acrylic or non-acrylic binders. Non-limiting examples of non-acrylic binders include cellulosic film formers such as nitrocellulose. Non-limiting examples of acrylic binders include those formed from the polymerization of (meth)acrylic acids, esters of (meth)acrylic acids, other acrylate monomers, styrene, and combinations thereof. In some embodiments, the coating composition includes at least about 0.5%, at least about 2%, at least about 5% or at least about 10%, or even at least about 15% by weight binder. For example, the coating composition may include from about 1% by weight to about 50% by weight binder. In some embodiments, the composition does not include a binder. The composition may include more than one binder with the total weight fraction of binder in the composition being as described above.

The coating composition may also include one or more dispersants. Generally, the dispersant acts to prevent the material suspended in the liquid solution (e.g., the metal or metal alloy material or pigments if present) from settling prior to application of the coating composition to the body 202. Non-limiting examples of suitable dispersants include stearalkonium hectorite and/or stearalkonium bentonite. In some embodiments, the coating composition includes at least about 0.5%, at least about 2%, at least about 5% or at least about 10%, or even at least about 15% by weight dispersant. For example, the coating composition may include from about 1% by weight to about 50% by weight dispersant. In some embodiments, the composition does not include a dispersant. The composition may include more than one dispersant with the total amount of dispersant in the composition being as described above.

Other ingredients suitable for use in the coating composition include emulsifiers, humectants, ancillary film formers, defoamers, plasticizers, preservatives, UV light absorbers, stabilizers, fragrances, moisturizers, and the like.

Non-limiting examples of techniques for applying the coating composition having metal or metal alloy material suspended in a liquid solution include brushing or aerosol spraying. In brushing applications, the coating composition may be painted with a brush (e.g., a foam brush) onto the body 202 of the lure 200. In aerosol spraying applications, the coating composition may be applied onto the body 202 of the lure 200 using a pressurized spray gun. In general, the coating composition when applied by aerosol spraying has a lower fluid viscosity than when applied by the brushing technique, to enable effective spraying of the coating composition. The brushing and/or spraying application may be performed under a ventilated hood, suitably at atmospheric pressures and at a temperature below the flash point of the coating composition. The coating composition on the body 202 of the lure 200 is subsequently dried, either by air-drying or a thermal treatment, to remove the medium. Once the medium is removed, the remaining film that includes the metal or metal alloy material (e.g., tungsten or tungsten alloy) forms the coating 210. In some embodiments, the coating composition may be applied and subsequently dried to remove the medium several times, forming several overlaying films of the metal or metal alloy material, to reach a desired thickness of the coating 210.

In some suitable embodiments, the lure 200 can be sold to the consumer with the coating 210 already applied to the body 202. In one such embodiment, for example, the coating 210 is applied to the body of the lure 200 prior to the lure 200 being packaged by the lure manufacture for sale. It is contemplated that the lure 200 or a plurality of the lures, with or without the coating 210 being applied to the body 202, can be packaged for sale as a kit with a suitable supply of the coating 210 so that the consume can apply or reapply the coating to body of the lure. In one such embodiment, for example, at least one lure 200 is package with a suitable supply of the coating 210 and an applicator to apply the coating to the body 202 of the lure.

Referring now to FIG. 3, in operation, the lure 200 including the coating 210 is attached to a fish line 118 of fishing rod 116. The lure 200 is deployed (e.g., by the user 114 casting the line 118) into a body of water 120 on which the vessel 112 floats. The body 202 and the decorative element 204 of the lure 200 are designed to attract fish and entice the fish to “bite” one or more of the hooks 206 to thereby hook the fish onto the lure 200. With the fish hooked, the lure 200 can subsequently be reeled by the user 114 onto the vessel 112 using the fishing rod 116.

To identify the location of the fish in the water 120, the sonar transducer 106 of the sonar tracking device 102 transmits sonar signals 122 into the water 120. Fish and other objects obstruct the path of the sonar signals 122 and produce reflections or echoes that are received by the sonar tracking device 106, processed by the imaging module 108, and sonar images thereof are displayed on the display 110. In addition, the coating 210 on the lure 200 enables the lure 200 to obstruct and adequately produce reflections of the sonar signals so that the location of the lure 200 is displayed on the display 110. Thereby, the user 114 is able to position the lure 200 (e.g., via fishing rod 116) to be closer in proximity to the fish located on the display 110. processes the sonar signals received by the sonar transducer 106.

It is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

A computing device can be programmed to execute the steps of the method of the present invention. A computing device for use with the present invention can be loaded with a non-transitory computer readable medium configured to execute activities associated with the present invention. The computing device can be incorporated into the sonar system. Alternately, the computing device can be networked to a server or other computing device configured to execute activities associated with the system. The computing device can also be networked to the sonar either wired or wirelessly in order to obtain the information from the sonar for processing. The information from the sonar can also be input into the computing device manually or using magnetic, optical, or other computer readable medium.

As used herein, a non-transitory computer readable medium can be any article of manufacture that contains data that can be read by a computer. Such computer readable media includes but is not limited to magnetic media, such as a floppy disk, a flexible disk, a hard disk, reel-to-reel tape, cartridge tape, cassette tape or cards; optical media such as CD-ROM and writeable compact disc; magneto-optical media in disc, tape or card form; and paper media, such as punched cards and paper tape. The computer readable medium contains code such that the method described herein can be executed.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A fishing attractant for use in combination with a sonar tracking device, the fishing attractant comprising an outer surface that is at least partially coated with a composition that enhances tracking of the fishing attractant by the sonar tracking device, the composition including at least one metal or metal alloy for reflecting a sonar beam transmitted by the sonar tracking device.

2. The fishing attractant of claim 1, wherein the metal or metal alloy comprises a tungsten metal or tungsten alloy.

3. The fishing attractant of claim 1, wherein the composition comprises the metal or metal alloy in an amount of 1%-10% by weight of the composition.

4. The fishing attractant of claim 1, wherein the composition further comprises mediums, binders, dispersants emulsifiers, humectants, ancillary film formers, defoamers, plasticizers, preservatives, UV light absorbers, stabilizers, fragrances, moisturizers, or mixtures thereof.

5. The fishing attractant of claim 4, wherein the medium is water, alcohols, ketones, acetates, or mixtures thereof.

6. The fishing attractant of claim 5, wherein the alcohol is a C1 to C10 alcohol, isopropyl alcohol, ethanol, or mixtures thereof.

7. The fishing attractant of claim 4, wherein the ketone is acetone, methyl ethyl ketone, diethyl ketone, or mixtures thereof.

8. The fishing attract of claim 4, wherein the binder comprises acrylic binders or non-acrylic binders, or mixtures thereof.

9. The fishing attractant of claim 1, wherein the fishing attractant is either an artificial lure or a live bait.

10. A composition for enhancing tracking of a fishing attractant by a sonar tracking device, wherein the composition comprises:
a medium;
a metal or metal alloy.

11. The composition of claim 10, wherein the metal or metal alloy comprises a tungsten metal or tungsten alloy.

12. The composition of claim 11 wherein the tungsten metal or tungsten alloy has a purity greater than 90%.

13. The composition of claim 10, wherein the composition comprises the metal or metal alloy in an amount of 1%-10% by weight of the composition.

14. The composition of claim 10, further comprising one or more additives.

15. The composition of claim 14, wherein the one or more additives are selected from mediums, binders, dispersants emulsifiers, humectants, ancillary film formers, defoamers, plasticizers, preservatives, UV light absorbers, stabilizers, fragrances, moisturizers, or mixtures thereof.

16. A method of enhancing tracking of a fishing attractant by a sonar tracking device, the method comprising:
applying a composition comprises a metal or metal alloy on an outer surface of a fishing attractant.

17. The method of claim 16, wherein the metal or metal alloy comprises a tungsten metal or tungsten alloy.

18. The method of claim 16, wherein the composition further comprises mediums, binders, dispersants emulsifiers, humectants, ancillary film formers, defoamers, plasticizers, preservatives, UV light absorbers, stabilizers, fragrances, moisturizers, or mixtures thereof.

19. The method of claim 16, wherein applying the composition comprises brushing the composition on a fishing attractant.

20. The method of claim 16, wherein applying the composition comprises spraying the composition on a fishing attractant.
